(19) United States
(12) Patent Application Publication
(10) Pub. No.: US 2015/0191386 A1
(43) Pub. Date: Jul. 9, 2015

(54) SEPARATOR AND COMPOSTING SYSTEM AND METHOD

(71) Applicant: BIOTURBINE SYSTEMS INC., Ville Saint-Laurent, CA (US)

(72) Inventor: Paul Mayrand, Ville Saint-Laurent (CA)

(73) Assignee: BIOTURBINE SYSTEMS INC., Ville Saint-Laurent (CA)

(21) Appl. No.: 14/408,796

(22) PCT Filed: Jul. 16, 2013
(86) PCT No.: PCT/CA2013/050554

§ 371 Date: Dec. 17, 2014

Related U.S. Application Data
(60) Provisional application No. 61/676,517, filed on Jul. 27, 2012.

(51) Int. Cl. C02F 11/12; C05F 17/02; C05F 7/00

(52) U.S. Cl. CPC C02F 11/126; C05F 7/00; C05F 17/0258

(57) ABSTRACT

A separator and composting unit for a sewage treatment system. The separator and composting unit receives sewage at a rotating separator that drains, or partially drains, the sewage of its liquid. The separator transfer the partially drained sewage to a rotating composting drum wherein the partially drained sewage dries out and transforms to compost while on its way to an exit opening of the composting drum from which it falls out.

### CROSS REFERENCE TO RELATED APPLICATIONS

This application claims the benefit of priority of U.S. Provisional Patent Application No. 61/676,517 filed Jul. 27, 2012, which is incorporated herein by reference in its entirety.

### FIELD

The present disclosure relates generally to waste water (domestic sewage) treatment. More particularly, the present disclosure relates to a system and method for the separation of solids from domestic sewage and for the composting of the solids.

### BACKGROUND

Water management is becoming increasingly important, especially in water-scarce regions of the world, such as, for example, the Sun Belt in the U.S.A. In such regions, water taxes are usually high and, as such, there is a strong incentive to conserve and recover water.

Further, the management and treatment of sewage water is also becoming increasingly important due to costs associated thereto, environmental concerns, and stricter disposal criteria.

In areas were a municipal sewage system is not available, decentralized sewage systems such as, for example, septic tanks can be used. Such septic tanks usually have two compartments, with a first compartment receiving wastewater, and the second compartment outputting treated water to a leach field (also referred to as a drain field or seepage filed), which can span over a large area, for example, from 200 to 300 m² for a three-bedroom house. Solids in the wastewater fall to the bottom of the first compartment while scum floats to the surface. A divider between the first and second compartments has an opening that allows scummy water to flow from the first to the second compartment where additional settling of solids in the water can occur. Anaerobic bacterial activity in the first and second compartments turns the solid deposits into sludge. The liquid present in the second compartment proceeds through the output of the septic tank, into the leach field where the impurities present in the water decompose in the soil.

Decentralized source separation sewage systems other than septic tanks exist and can allow separation of solids from sewage. However, the separation of the solids from the sewage typically requires a separator and composting device that can be bulky and difficult to service.

Therefore, improvements in separator and composting devices for sewage treatment are desirable.

### SUMMARY

In an aspect of the present disclosure, there is provided a separator and composting unit that comprises: a core assembly; a separator for receiving sewage, the separator having draining slots defined therein, the draining slots to enable liquid in the sewage to drain out of the separator to obtain partially drained solids in the separator; and a composting drum, the separator and the composting drum to be rotatably driven about the core assembly, the core assembly defining a passageway between the separator and the composting drum, the separator to displace the partially drained solids toward the passageway upon being rotated, the partially drained solids to enter the passageway upon reaching the passageway, the passageway to transfer the partially drained solid having entered the passageway to the composting drum.

### BRIEF DESCRIPTION OF THE DRAWINGS

Embodiments of the present disclosure will now be described, by way of example only, with reference to the attached Figures.

FIG. 1 shows a perspective view of an embodiment of a separator and composting system in accordance with the present disclosure.

FIG. 2 shows another perspective view of the separator and composting system of FIG. 1.

FIG. 3 shows a perspective view of an embodiment of a separator used in the separator and composting system of FIG. 1.

FIG. 4 shows a transverse cross-sectional view of the separator of FIG. 3.

FIG. 5 shows a perspective view of an embodiment of a core assembly that can be used in the separator and composting system of FIG. 1.

FIG. 6 shows another perspective view of the core assembly of FIG. 5.

FIG. 7 shows a partial perspective view of an embodiment of a draining chamber and composting drum of the separator and composting system of FIG. 1.

FIG. 8 shows a transverse cross-sectional view of the composting drum shown in FIGS. 1 and 7.

FIG. 9 shows another perspective view of the separator of FIG. 3.

FIG. 10 shows an open view of the separator of FIG. 9.

FIG. 11 shows a perspective view of a draining chamber and composting drum of the separator and composting system of FIG. 1.

FIG. 12 shows a perspective view of another embodiment of a separator and composting system of the present disclosure.

FIG. 13 shows a side view of the separator and composting system of FIG. 12.

FIG. 14 shows a front view of the separator and composting system of FIG. 12.

FIG. 15 shows a perspective view of a separator in accordance with certain embodiments of the present disclosure.

FIG. 16 shows an open view of the separator of FIG. 15.

FIG. 17 shows another perspective view of the separator of FIG. 15.

FIG. 18 shows an assembly of hoops in accordance with certain embodiments of the present disclosure.

FIG. 19 shows a close view of gaps and slots defined in the separator of FIG. 15.

FIG. 20 shows an open, cross-sectional view of the separator of FIG. 15.

FIG. 21 shows a perspective view of an embodiment of a core assembly in accordance with certain embodiments of the present disclosure.

FIG. 22 shows a top view of the core assembly of FIG. 21.

FIG. 23 shows a perspective view of certain element of the separator and composting system of FIG. 12.

FIG. 24 shows another perspective view of the core assembly of FIG. 21.

FIG. 25 shows a side view of the separator and composting system of FIG. 12.

FIG. 26 shows an open, side view of the separator and composting system of FIG. 12.

FIG. 27 shows a perspective view of elements of a composting drum in accordance with certain embodiments of the present disclosure.

FIG. 28 shows a perspective view of a composting drum in accordance with certain embodiments of the present disclosure.

FIG. 29 shows another perspective view of the composting drum of FIG. 28.

FIG. 30 shows an open, cross-sectional view of the composting drum of FIG. 28.

FIG. 31 shows a perspective view of a core assembly in accordance with certain embodiments of the present disclosure.

FIG. 32 shows a top view of the core assembly of FIG. 31.

FIG. 33 shows another perspective view of the core assembly of FIG. 31.

FIG. 34 shows a perspective view of the separator and composting system of FIG. 12.

FIG. 35 shows a front view of a hoop in accordance with certain embodiments of the present disclosure.

FIG. 36 shows a front view of a hoop in accordance with other embodiments of the present disclosure.

FIG. 37 shows a front view of the separator and composting system of FIG. 33.

FIG. 38 shows a close-up view of a scraper structure in accordance with certain embodiments of the present disclosure.

FIG. 39 shows an open view of a separator in accordance with certain embodiments of the present disclosure.

FIG. 40 shows a close-up view of another scraper structure in accordance with certain embodiments of the present disclosure.

### DETAILED DESCRIPTION

Generally, the present disclosure provides a method and system for separating solids from sewage and for composting the separated solids.

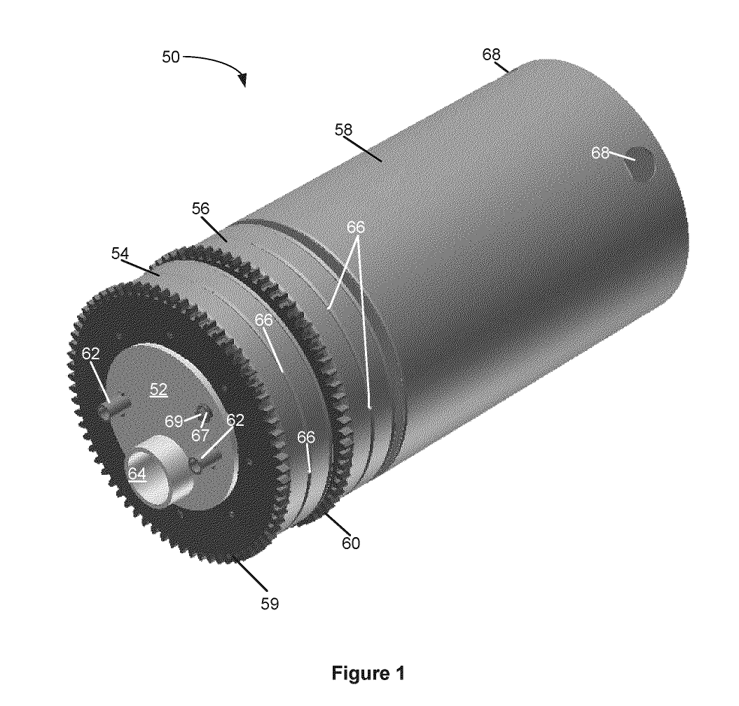

FIG. 1 shows a perspective view of an embodiment of a separator and composting system 50 of the present disclosure. The separator and composting system can also be referred to as a separator-composting system or as a separator-composting unit. As will be discussed elsewhere in the disclosure, the separator and composting system 50 can be made part of a waste water treatment system.

The separator-composting unit 50 comprises a core assembly 52 about which a separator 54, a draining chamber 56, and a composting drum 58 can revolve. The separator 54 has a gear 59 fixedly secured thereto. The separator 54 and its gear 59 can be rotated about the core assembly 52. The draining chamber 56 has a gear 60 fixedly secured thereto. The composting drum 58 and the draining chamber 56 are fixedly secured to each other. As such, the draining chamber 56, the composting drum 58, and the gear 60 can rotate together about the core assembly 52. Further, the draining chamber 56, the composting drum 58, and the gear 60 are not fixedly secured to the separator 54 and the gear 59, and can therefore be rotated about the core assembly 52 independently from the separator 54 and the gear 59. The gears 59 and 60 can be driven at different speeds by any suitable gear driving arrangement. As an example, the gear 59, and the separator 54 can be driven a one revolution per hour, and he gear 60, and the separator 56, and the composting drum 58, can be driven at one revolution per day. Any other suitable rotation speeds are also within the scope of the present disclosure.

The separator-composting unit 50 can be 45 inches in length and 20 inches in diameter. The diameter can be tapered slightly such that the separator-composting unit 50 has a lesser diameter near the openings 68 than at others regions of the separator-composting unit 50. Any other suitable dimensions are to be considered within the scope of the present disclosure.

The core assembly 52 has support members 62 and a sewage inlet 64. The sewage inlet can have a diameter of four inches or any other suitable diameter. As will be shown further below, the support member 62 can have counterpart support members located on the opposite side of the core assembly 52. The support members of the present embodiment are to fit into cooperating holding structures located, for example, in a waste water treatment system, to hold the core assembly in a fixed orientation (e.g., horizontally) with respect to the waste water treatment system. The core assembly 52 also has a cleaning access 67 shown plugged by a plug 69.

The sewage inlet 64 is to receive waste water (sewage) from a sewage outlet. The separator-composting unit 50 has a series of slots 66 at the periphery of the separator 54 and at the periphery of the draining chamber. The slots (draining slots) 66 extend along the circumference of the separator. The composting drum has openings 68 (e.g., four openings) at the periphery of the composting drum, the openings 68 can be at an end region of the composting drum 58. There can be any suitable number of slots 66 and openings 66 without departing from the present disclosure. The width of the slots 66 can be 0.04 inch or any other suitable width. The length of the slots 66 can be, for example, of the order of 5 to 20 cm. The diameter of the openings 68 can be 3 inches or any other suitable diameter.

As will be described in further details below, sewage enters the sewage inlet 64 and propagates to the separator 54. At the separator, most of the liquid in the sewage exit the separator 54 through the slots 66 of the separator, leaving behind partially drained solids. As the separator 54 rotates, the partially drained solids are forwarded to the draining chamber 56. Once in the draining chamber 56, the partially drained solids will further drain itself from liquid through the slots 66 of the draining chamber 56. As the draining chamber will generally rotate at a lower speed than the separator 54, the partially drained solids will have a greater draining time in the draining chamber than in the separator 54. As the draining chamber 56 rotates, the further drained solids are forwarded to the composting drum 58. As composting drum 58 rotates, the partially drained solids will propagate towards the openings 68 through which it will exit in compost form. A removable compost bin (not shown) can be placed under the openings 68 to collect the compost.

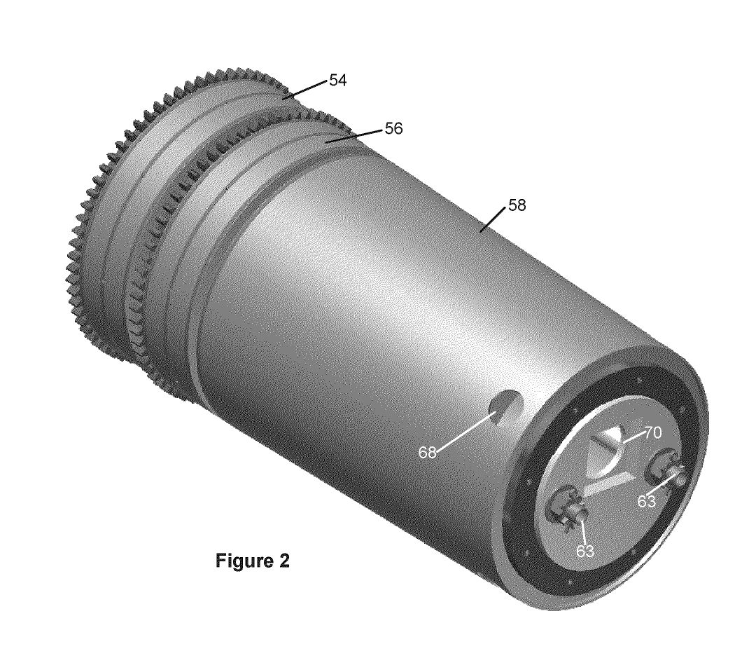

FIG. 2 shows a different perspective view of the embodiment of FIG. 1. FIG. 2 shows support members 63 (the counterpart support members referred to above) as well as a venting outlet 70, which can vent the air that comes in the separator-composting unit through the sewage inlet 64.

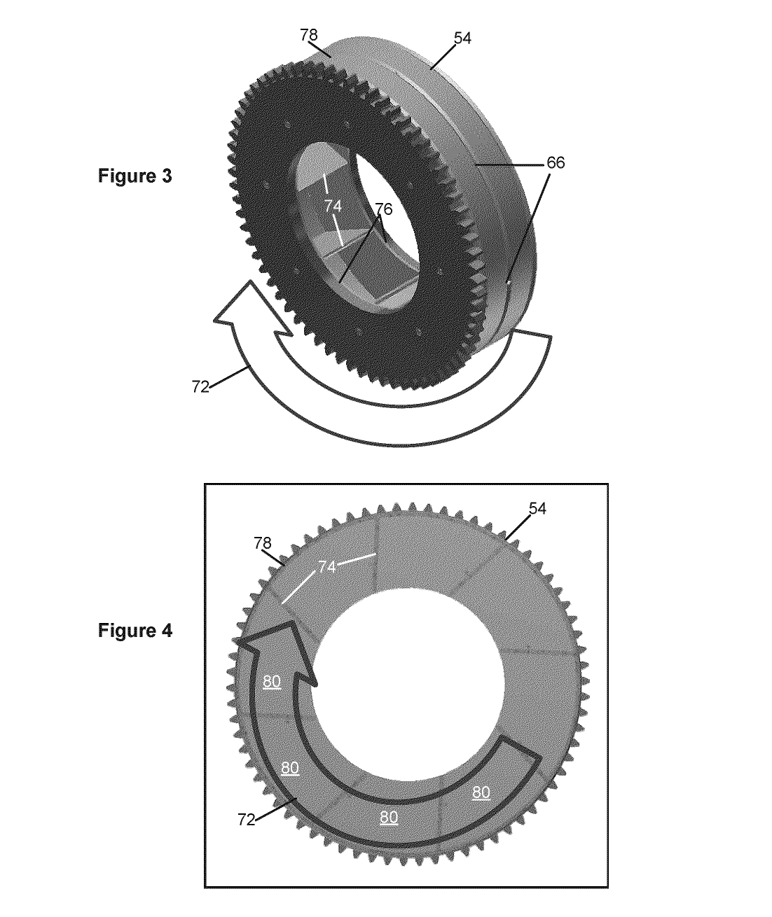

FIG. 3 shows a perspective view of the separator 54. An arrow 72 indicates the rotation direction of the separator 54. The separator 54 has a series of blades 74 that extend between opposite walls 76 of the separator. Within the context of the present disclosure, the blades 74 can also be referred to as vanes. When the separator 54 is installed on the core assembly 52, the blades 74 extend from the inside of the peripheral wall 78 of the separator 54 towards the core assembly 52. Slots 66 are also shown in FIG. 3.

FIG. 4 shows a transverse cross-sectional view of the separator 54. The separator has a plurality of compartments 80 separated form each other by blades 74. As shown in FIG. 4, in the present embodiment, the blades 74 are not perpendicular to the inside of the peripheral wall 78. However, the blades can be at any suitable angle to the peripheral wall without departing from the scope of the present disclosure. Any suitable number of blades 74 can be comprised in the separator 54.

Sewage entering the core assembly 52 though the sewage inlet 64 falls into a compartment 80 of the separator 54. As the separator 54 rotates and some of the liquid in the sewage drains from the separator 54 through the slots 66, the partially drained solids rise with respect to the bottom of the core assembly. As will be described next, the core assembly defines a slanted passageway in which the partially drained solids fall and, through gravity, propagate to the draining chamber 56, which can, in some embodiments, be structurally and functionally the same as the separator 54.

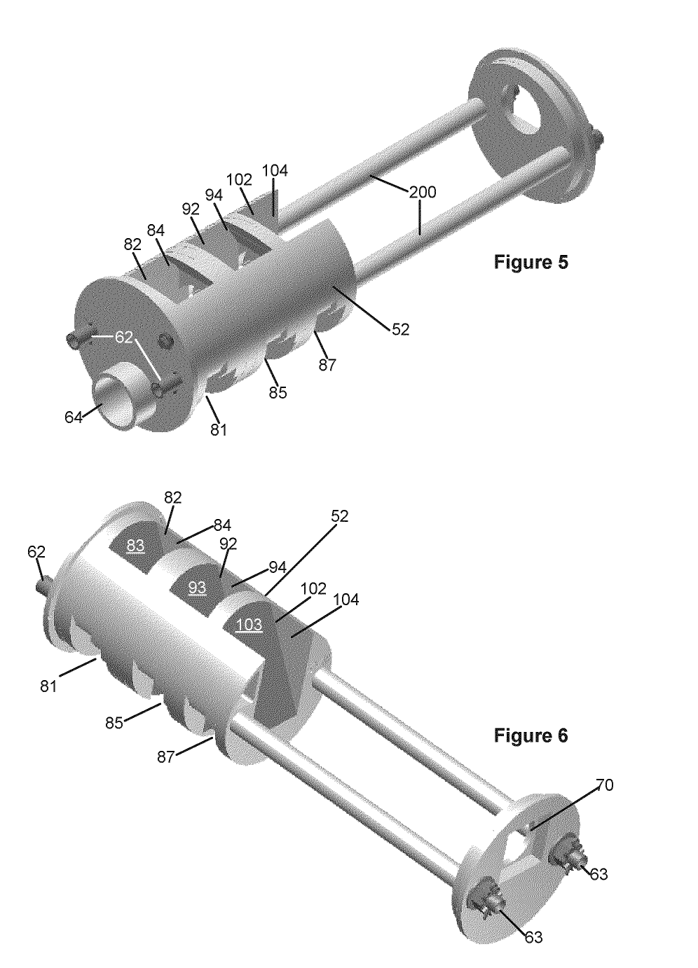

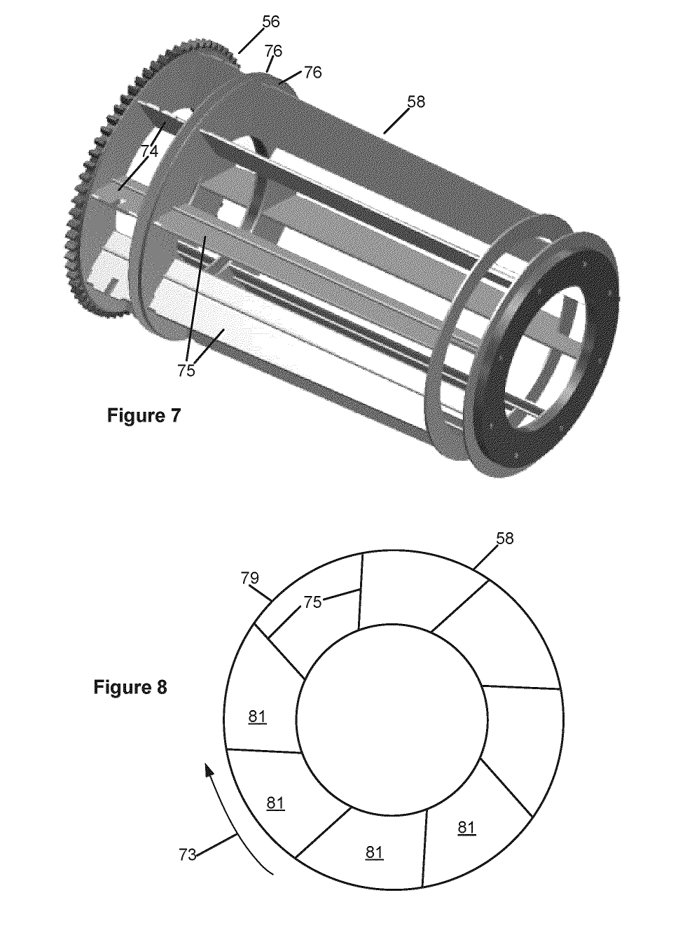

FIGS. 5 and 6 show perspective views of the core assembly 52. With reference to FIG. 5, when the separator 54 and the core assembly are assembled together, the sewage entering the core assembly 52 through the sewage inlet 64 falls through an opening 81 into a compartment 80 of the separator 54. Once in the compartment 80, which is rotating with the separator 54, the sewage partially drains through the slots 66 of the separator and the partially drained solids rise. The partially drained solids fall into an opening 82 of the core assembly 52 when the chamber in question reaches the opening 82 of the core assembly. The opening 82 is that of a passageway 84 that extends from the top of the core assembly 52 towards the bottom of the core assembly 52, at an angle such that, when the draining chamber 56 is assembled with the separator 54 and the core assembly 52, the output of the passageway 84 delivers the partially drained solids to the bottom of the draining chamber 56. The angle at which the passageway is inclined can be 60° or any other suitable angle that allows the partially drained solids to propagate from the separator 54 to the draining chamber 56. FIG. 6 shows a slanted wall 83 of the passageway 84. At the bottom of the passageway 84 is an opening 85 through which the partially drained solids that entered the passageway at the opening 82 falls into the draining chamber 56. In the present embodiment, the support member 62 and 63 are opposite ends of longitudinal members 200 shown in FIG. 5.

In the present embodiment, the draining chamber 56 is substantially a copy of the separator 54 (however, this need not be the case). As such, the reference numerals of FIGS. 3 and 4 are used to describe the draining chamber 56. When the separator 54, draining chamber 56, and the core assembly are assembled together, the partially drained solids entering the draining chamber 56, through the opening 85 of the core assembly 52, falls into a compartment 80 of the draining chamber 56 (see FIGS. 3 and 4). Once in the compartment 80, which is rotating with the draining chamber 56, the partially drained solids can be further drained through the openings 66 of the draining chamber and the further drained solids rise as the draining chamber 56 rotates. The further drained solids fall into an opening 92 of the core assembly 52 when the chamber in question reaches the opening 92 of the core assembly. The opening 92 is that of a passageway 94 that extends from the top of the core assembly 52 towards the bottom of the core assembly 52, at an angle such that, when the composting drum 58 is assembled with the draining chamber 56, the separator 54 and the core assembly 52, the output of the passageway 94 delivers the further drained solids to the bottom of the composting drum 58. The angle at which the passageway 94 is inclined can be 60° or any other suitable angle that allows the further drained solids to propagate from the draining chamber 56 to the composting drum 58. FIG. 6 shows a slanted wall 93 of the passageway 94. At the bottom of the passageway 94 is an opening 87 through which the further drained solids that entered the passageway 94 at the opening 92 falls into the composting drum 58.

FIG. 7 shows a perspective view of the draining chamber 56 and the composting drum 58 but without their peripheral walls. FIG. 7 shows the blades 74 of the draining chamber 56 and blades 75 of the composting drum 58. Within the context of the present disclosure, the blades 75 can also be referred to as vanes. The blades 75 and the peripheral wall of the composting drum 58 define compartments similar to the compartments 80 of the separator 54 and the draining chamber 56 (see FIGS. 3 and 4). The adjacent walls 76 of the draining chamber 56 and the composting drum 58 can be secured together through any suitable means such as bolts and or adhesives, welding, etc. A spacer that interconnects draining chamber 56 and the composting drum 58 can be provided between the adjacent walls 76. FIG. 8 shows a transversal cross-sectional view of the composting drum 58, which has the blades 75 and a peripheral wall 79 that together define compartments 81. The arrow 73 indicates the direction of rotation of the composting drum 58.

Returning to FIGS. 5 and 6, when the separator 54, the draining chamber 56, the composting drum 58 and the core assembly 52 are assembled together, the further drained solids entering the composting drum 58, through the opening 87 of the core assembly 52, falls into a compartment 81 of the composting drum 58 (see FIG. 8). Once in the compartment 81, which is rotating with the composting drum 58, the further drained solids rises as the composting drum 58 rotates. The further drained solids falls into an opening 102 of the core assembly 52 when the chamber in question reaches the opening 102 of the core assembly 52. The opening 102 is that of a channel 104 that extends from the top of the core assembly 52 towards the bottom of the composting drum 58, at an angle such that the output of the channel 104 delivers the further drained solids to the bottom of the composting drum 58 closer towards the openings 68 of the composting drum 58. The angle at which the passageway 94 is inclined can be 60° or any other suitable angle that allows the further drained solids to propagate closer to the openings 68. As more and more drained and composting solids flows out of the opening 87, the drained and composting solids propagates towards the openings 68.

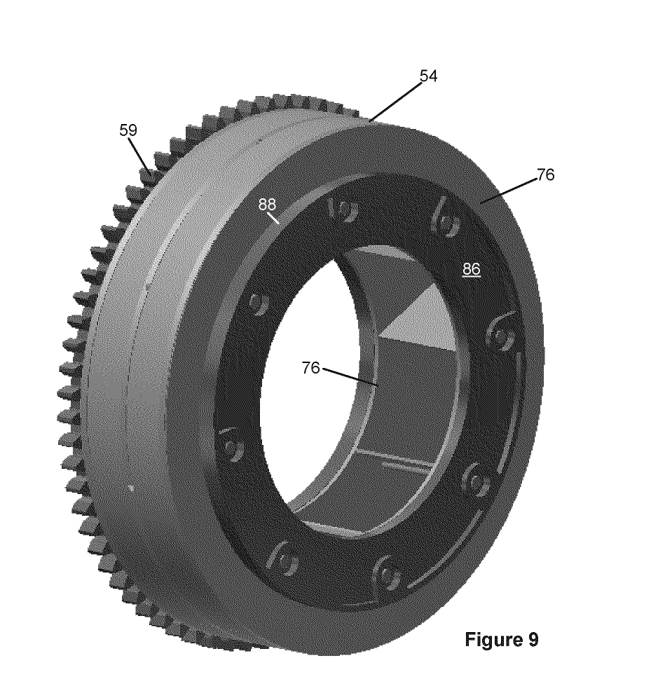

FIG. 9 shows another perspective view of the separator 54. The separator 54 has a plate 86 that has an outer perimeter 88 than can fit into the inner diameter of the gear 60 of the draining chamber 56 (see FIG. 1) to form a bushing.

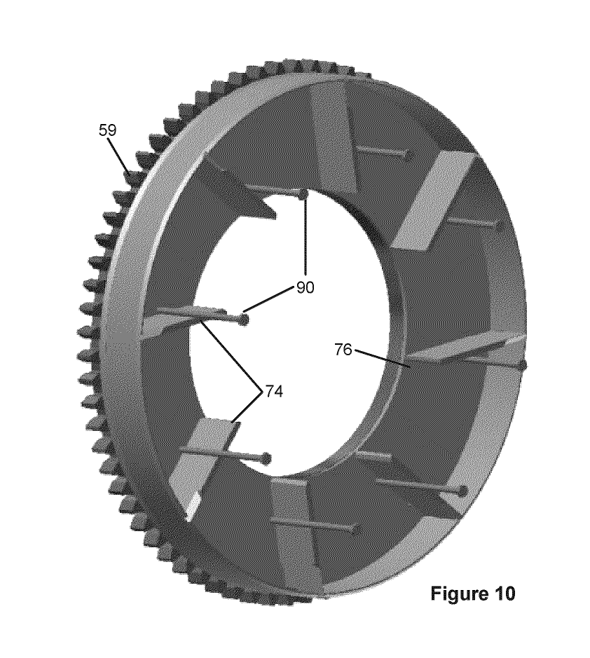

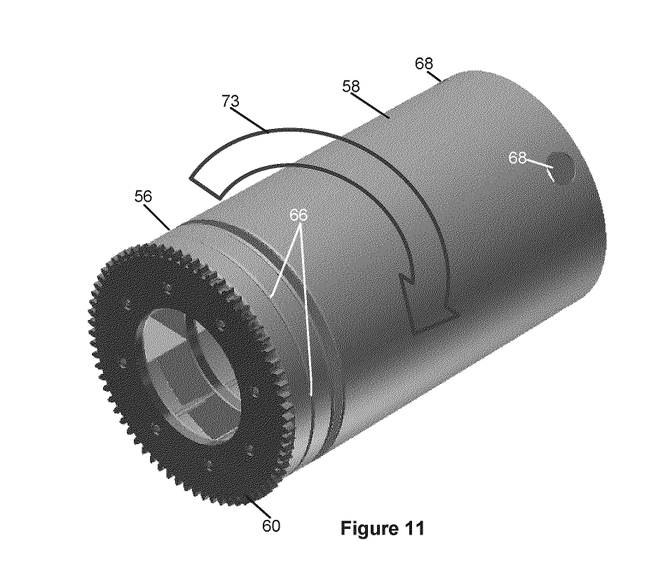

FIG. 10 shows the same perspective view as in FIG. 7 but without the plate 86 and without one of the walls 76. In the present embodiment, bolts 90 can be used to connect the gear 59 to the plate 86 (see FIG. 9). Any other suitable fastener can be used without departing from the scope of the present disclosure.

FIG. 11 shows a perspective view of the draining chamber 56 and the composting drum 58 fixedly secured to each other. The arrow 73 indicates the rotation direction of the draining chamber 56 and the composting drum 58.

The separator and composting system of the present disclosure can separate human feces, toilet paper, and kitchen waste from domestic wastewater. After separation of some of liquid and solids of the sewage entering the separator 54, the partially drained solids (solids and some liquid) enters the draining chamber where a more thorough drainage is completed. This further drained solids enter the composting drum 58 and, after about 20 days, composted solids exit the composting drum 58 through the openings 68. The composted solids can be collected in any suitable compost bin or receptacle.

In testing an embodiment of the present disclosure, separation rates of solids from sewage are about 90%. In further results of testing, the quality of the compost (composted solids) is such that there are no repulsive odours, the water content of the compost is reduced to less than 60%, and the fecal coliform levels are lower than the National Science Foundation (NSF) 41 standards. Having the compost confined to a rolling composting drum allows good management practice and if desired, final solar radiation.

The separation of the solids allows for the capture of about 50% of the phosphorus present in the sewage and produces compost. The present disclosure allows for waste water treatment to be simplified significantly. Further, nutriment reuse becomes a reality and sludge hauling can be reduced, if not eliminated. Compared to septic solutions: odours are reduce to a non repulsive level and Green Gas Emission (GGE) by-products are reduce by 90%. Additionally, separating solids from sewage will stimulate results in urine diversion, which can result in full nutriment reuse (phosphorus and nitrogen).

The separator-composting unit 50 (FIG. 1) can be made part of any suitable waste water treatment system and can be driven by any suitable means. For example, the separator-composting unit 50, and other embodiments of the separator-composting unit, can be driven by a turbine such as described in U.S. Pat. No. 8,197,201.

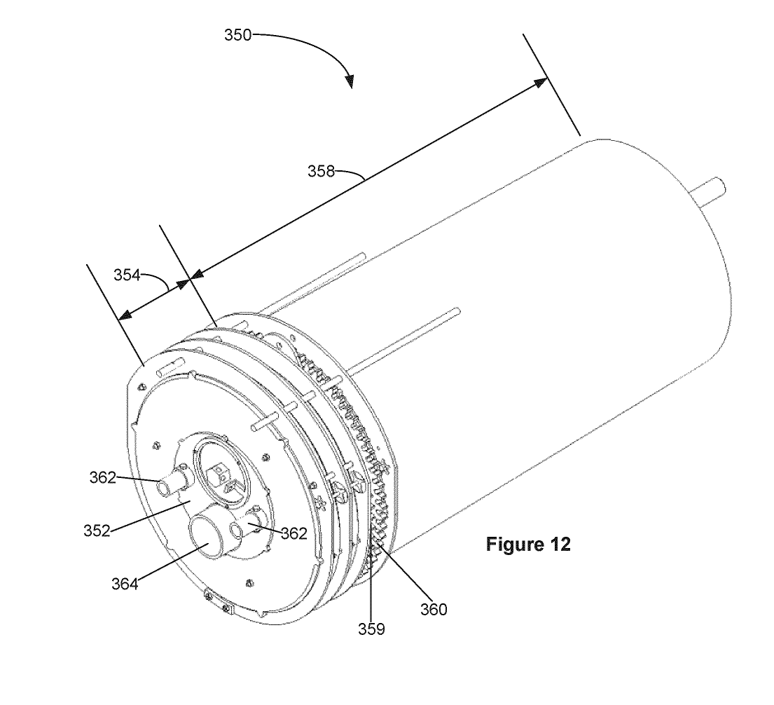

FIG. 12 shows a perspective view of another embodiment of a separator and composting system 350 of the present disclosure. The separator-composting unit 350 comprises a core assembly 352 about which a separator 354 and a composting drum 358 can revolve (rotate). The separator 354 has a gear 359 fixedly secured thereto. The separator 354 and its gear 359 can be rotated about the core assembly 352. The composting drum 358 has a gear 360 fixedly secured thereto and can be rotated about the core assembly 352. Further, the composting drum 358 and the gear 360 are not fixedly secured to the separator 354 and the gear 359, and can therefore be rotated about the core assembly 352 independently from the separator 354 and the gear 359. The gears 359 and 360 can be driven at different speeds by any suitable gear driving arrangement. As an example, the gear 359, and the separator 354 can be driven a one revolution per hour, and the gear 60 and the composting drum 58, can be driven at one revolution per day. Any other suitable rotation speeds are also within the scope of the present disclosure.

To service a dwelling occupied by five people the separator-composting unit 350 can be 45 inches in length and 20 inches in diameter. Any other suitable dimensions are to be considered within the scope of the present disclosure. Dwellings with larger occupancy can have a separator-composting unit 350 of larger dimensions. Alternatively, dwellings with larger occupancy can have a separator-composting unit of the same dimensions (45 inches in length and 20 inches in diameter) but with an additional heating element mounted in the separator-composting unit to dry the solids in the composting drum. This is described in greater details below.

The core assembly 352 is shown with support members 362 and a sewage inlet 364. The sewage inlet can have a diameter of three inches or any other suitable diameter. As will be shown further below, the support member 362 can extend through the core assembly 352. The support members of the present embodiment are to fit into cooperating holding structures located, for example, in a waste water treatment system, to hold the core assembly in a fixed orientation (e.g., horizontally) with respect to the waste water treatment system. The sewage inlet 364 is to receive waste water (sewage) from a sewage outlet.

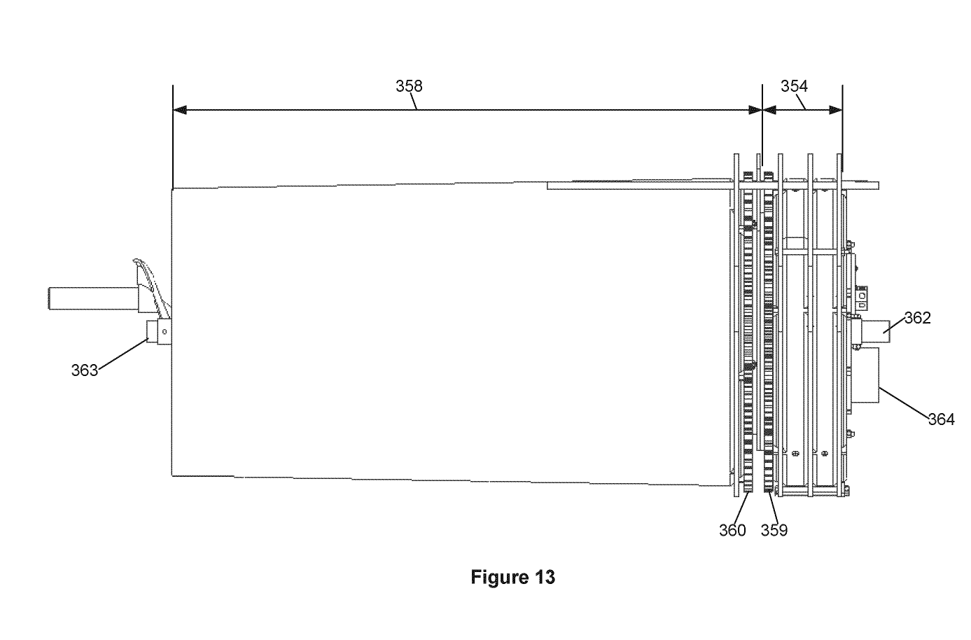

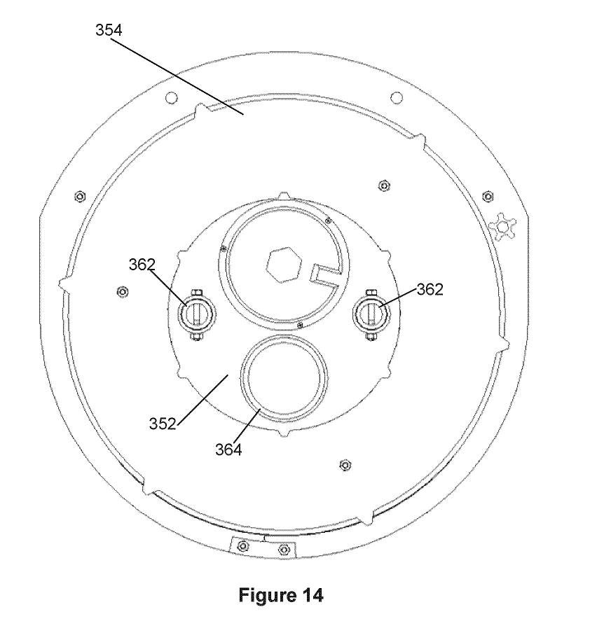

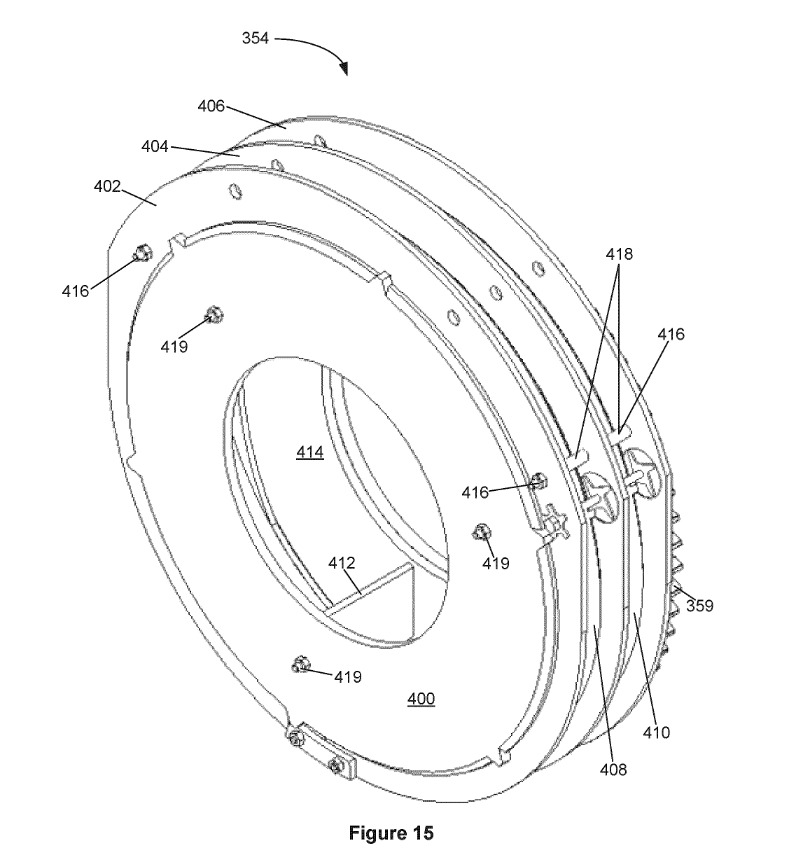

FIG. 13 shows a side view of the separator-composting unit 350. FIG. 14 shows a front view of the separator 354.

FIG. 15 shows a perspective view of the separator 354, which, in this example, is an assembly of several parts. The separator 354 comprises a front wall 400 and a back wall 414. The gear 359 is fixedly secured to the back wall 414 through any suitable means such as, for example, fasteners, adhesives, friction etc. In other embodiments, the gear 359 and the back wall can be monolithic (i.e., there can be a single piece defining the gear 359 and the back wall 414). Located between the front wall 400 and the back wall 414 are two circumference walls 408 and 410, as well as blades 412, which are fixedly secured to each other and to the front wall 400 as well as the back wall 414 and the gear 359. That is, the front wall 400, the circumference walls 408 and 410, the blades 412, the back wall 414, and the gear 359 are all rotatable together, as a unit, about the core assembly 352 of FIG. 12. Returning to the example of FIG. 15, the separator 354 also comprises three hoops 402, 404, and 406. The hoops 402, 404, and 406 are fixedly secured to each other, and aligned with each other, with, for example, fastener assemblies 416, which can include spacers 418 to maintain the hoops spaced apart at a fixed separation distance. The hoops 402, 404, and 406 do not rotate with the gear 359; rather, the hoops remain stationary, with respect to the core to the core assembly 352 of FIG. 12. Even though three hoops are shown, embodiments of separators with at least one hoop are also within the scope of the present disclosure. Within the context of the present disclosure, the blades 412 can also be referred to as vanes. In other embodiments the front wall 400, blades 412, back wall 414, and gear 359 can be a single molded part.

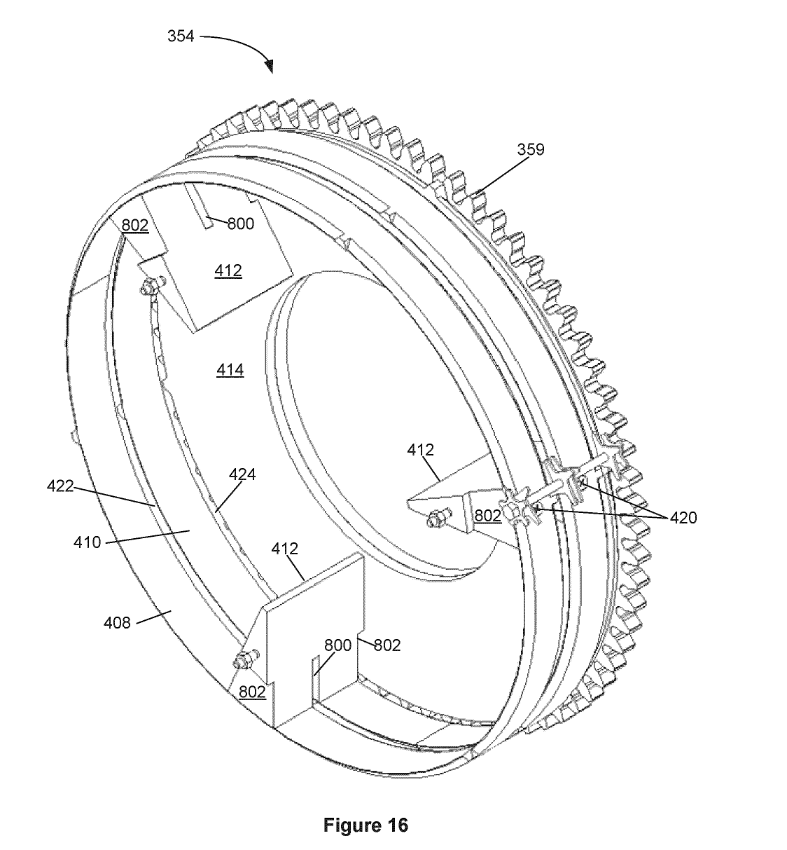

FIG. 16 shows the separator 354 of FIG. 15 but without the front wall 400 or the hoops 402, 404, and 406. The present embodiment of the separator 354 has three blades 412 that are wedge-shaped. However, separators with one or more blades, whether they be wedge-shaped or of any other suitable shape (e.g. curve-shaped, flat, inclined, etc.), are also within the scope of the present disclosure. The shape and features of the blades 412 is described in greater detail below.

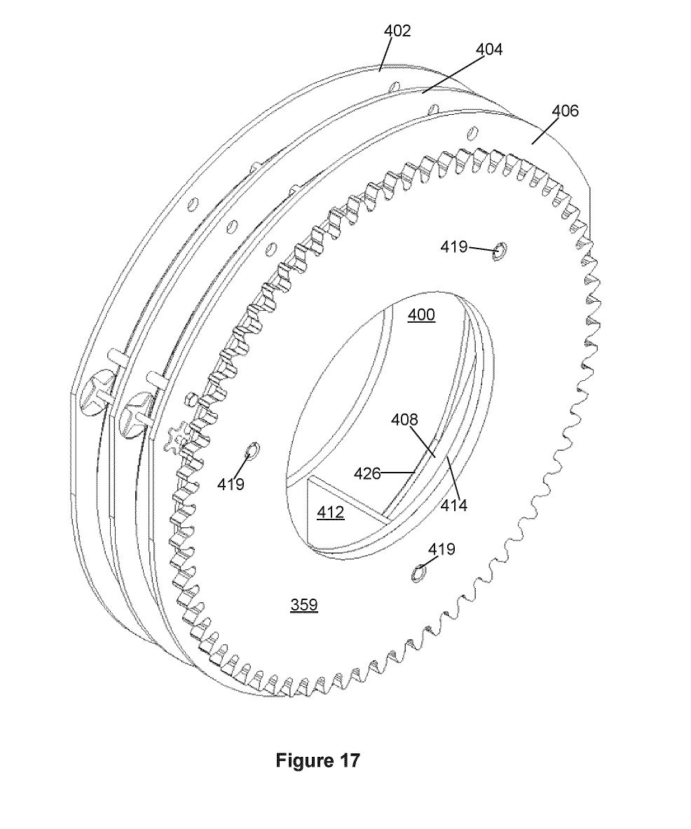

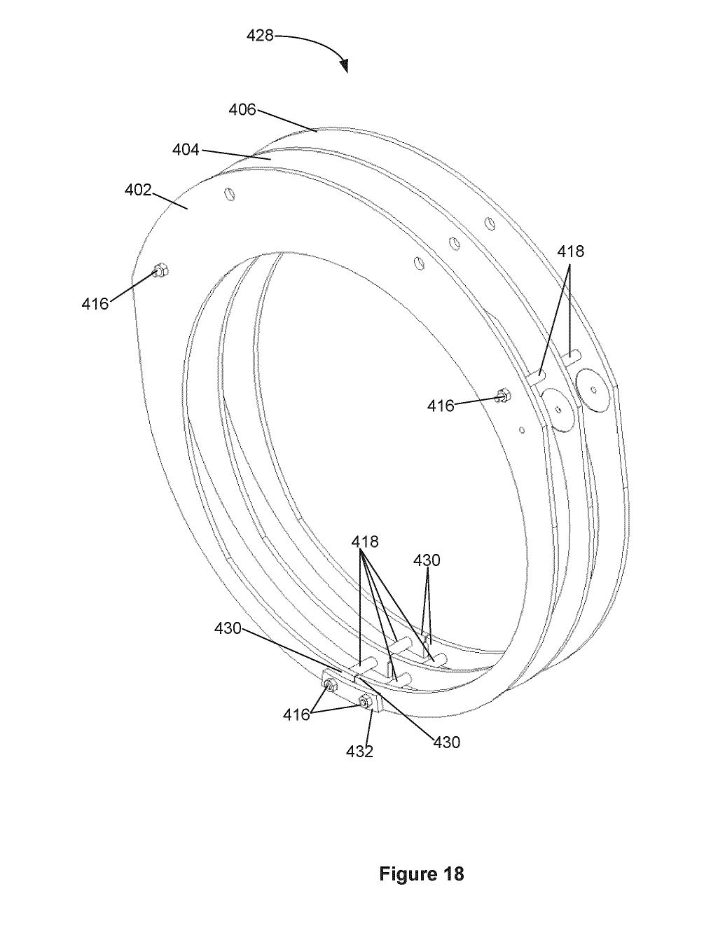

Referring again to FIG. 15, the front wall 400 is secured to the blades 412 with a bolt and nut arrangement 419. FIG. 17, which is another perspective view of the separator 354, shows how the gear 359 and the back wall 414 are secured to the blades 412 with the same bolt and nut arrangement. Any other fasteners, adhesive, welding rods, etc. can also be used to secure the front wall 400 to the blades 412 and the blades to the gear 359 and the back wall 414 without departing from the scope of the present disclosure.

Referring now to FIG. 16, the circumference walls 408 and 410 are fixedly secured to the blades 412 with screws 420 or with any other suitable fasteners, adhesive, welding rods, etc. or both. The circumference walls 408 and 410, and the blades 412, are dimensioned (sized) such that when the circumference wall 408 and 410 are secured to the blades 412, they define a gap 422 between the circumference walls 408 and 410. Further, the blades 412, the circumference wall 410 and the back wall 414 are dimensioned such that when secured to each other, there is a gap 424 between the back wall 412 and the circumference wall 410.

Referring now to FIG. 17, the blades 412, the circumference wall 408 and the front wall 400 are dimensioned such that when secured to each other, through the blades 412, there is a gap 426 between the front wall 400 and the circumference wall 408.

FIG. 18 shows a hoop assembly 428 that comprises the hoops 402, 404, and 406, as well as the fastener assemblies 416 with spacers 418. As shown in this example, the hoops can have ends 430 held together by members 432 secured to the hoops by fastener assemblies 416. The loops can be manufactured with a resilient material that allow for the ends 430 to be spread apart for placement of the hoops on the separator.

The hoops 402, 404 and 406 respectively fit in the gaps 426, 422, and 424. The thickness of each hoop 402,404, and 406 is less than the width of the respective gaps 426, 422, and 424. This allows sewage entering the separator 354 to be drained, or partially drained, of its liquid through the slots defined by the hoops 402, 404, and 406, and their respective gaps 426, 422, and 424.

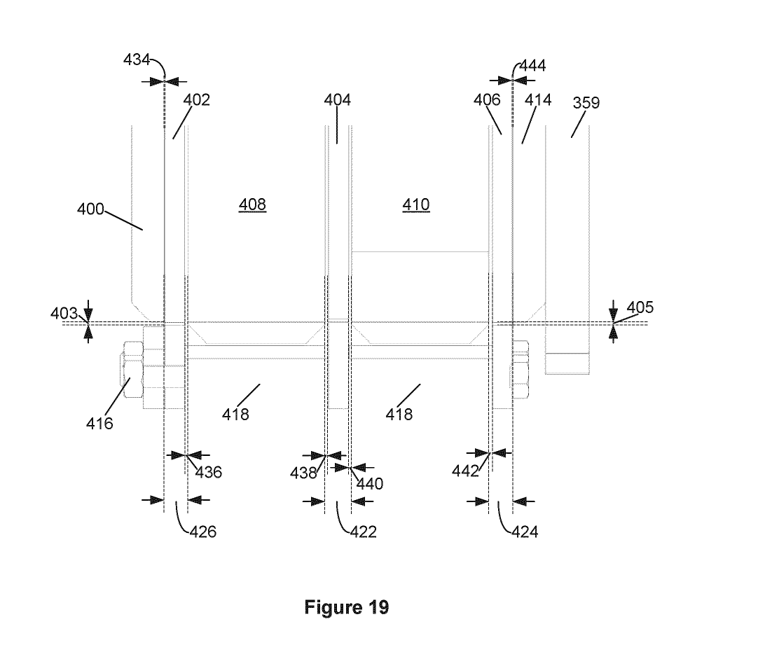

FIG. 19 shows a side, close-up view of the gap 426 defined by the front wall 400 and the circumference wall 408, the gap 422 defined by the circumference wall 408 and the circumference wall 410, and the gap 424 defined by the circumference wall 410 and the back wall 414. The hoop 402 is located in the gap 426, the hoop 404 is located in the gap 422, and the hoop 406 is located in the gap 424. The hoop 402 located in the gap 426 defines a slot 434 and a slot 436; the hoop 404 located in the gap 422 defines slots 438 and 440; the hoop 406 located in the gap 424 defines slots 442 and 444. It is through these slots 434, 436, 438, 440, 442, and 444 that liquid from sewage entering the separator 354 can drain. The width of the slots 436, 438, 440, and 442 can vary, for example, from 0.02 inch to 0.04 inch to prevent particles having a size greater than the slot with to be drained out of the separator. However, any other suitable widths that allow liquid to drain from the sewage without letting through solid particles greater a pre-determined size are also within the scope of the present disclosure. Even though liquid can drain from the slots 434 and 444, there presence also serves to reduce friction between the front wall 400 and the hoop 402, and between the hoop 402 and the back wall 414. The width of slots 434 and 444 can be narrower than that of the slots 436, 438, 440, and 442 and can range, for example, from 0.01 inch to 0.005 inch. The slots 436, 438, 440, and 442 can extend along the entire circumference of the separator 354 or only along a portion of the circumference without departing from the scope of the present disclosure. Further, the hoop 402 can have its internal diameter extend lower than the bottom of the front wall 400, to favor improved draining. This is shown in FIG. 19 at the slot 403. Furthermore, the hoop 406 can have its internal diameter extend lower than the bottom of the back wall 414, to favor improved draining. This is shown in FIG. 19 at the slot 405. The width of these slots 403 and 405 can vary, for example, from 0.02 inch to 0.04 inch.

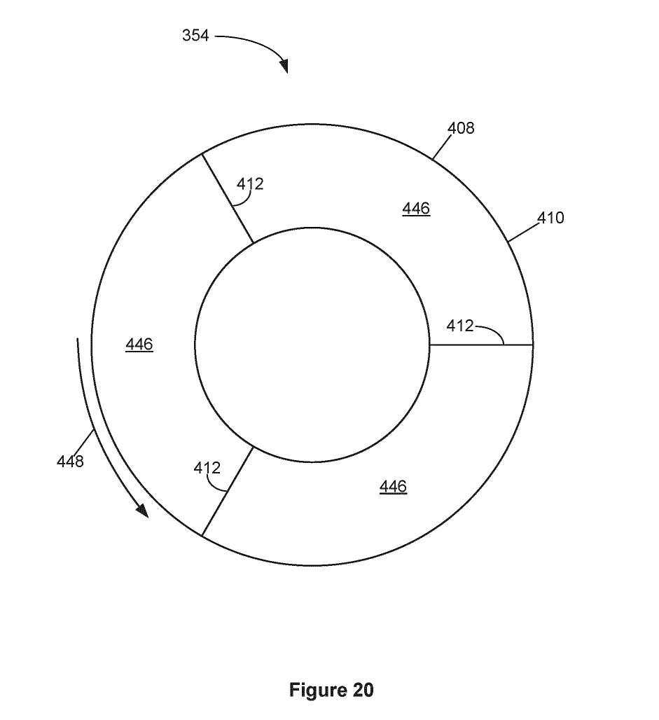

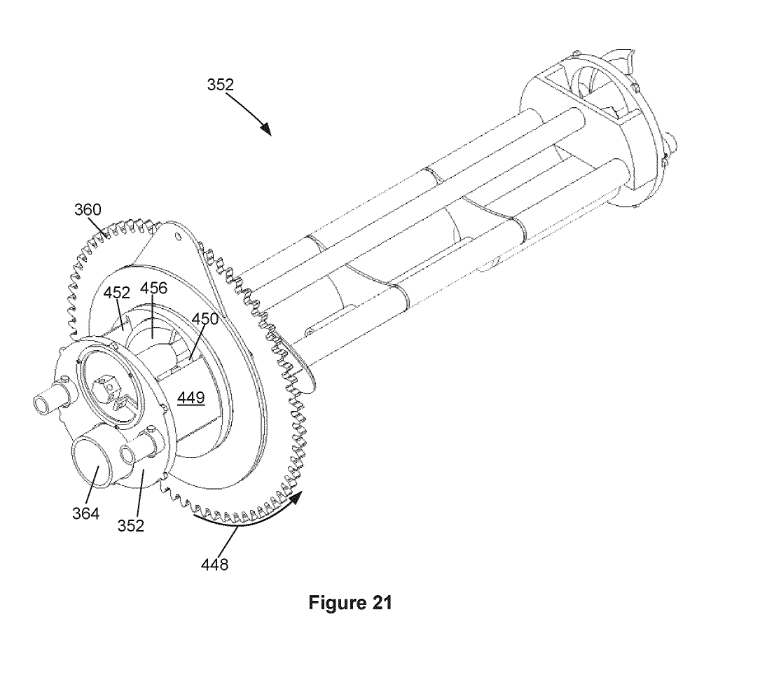

FIG. 20 shows a transversal, open cross-sectional view of the separator 354, which includes the blades 412 and the circumference walls 408 and 410. The view is from the standpoint of a person standing in front of the front wall 400 and looking toward the front wall 400. These elements, the blades 412 and the circumference walls 408 and 410, together with the front wall 400 and the back wall 414 define compartments 446. The arrow 448 indicates the direction of rotation of the separator 354. FIG. 21 shows a perspective view of the core assembly 352 to which the gear 360 is secured and about which the separator 354 rotates.

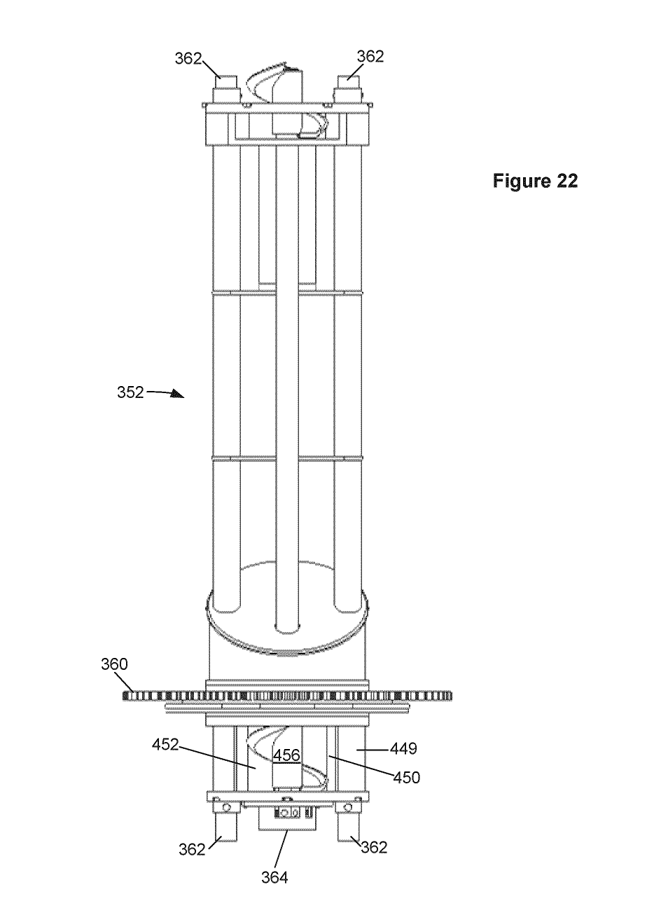

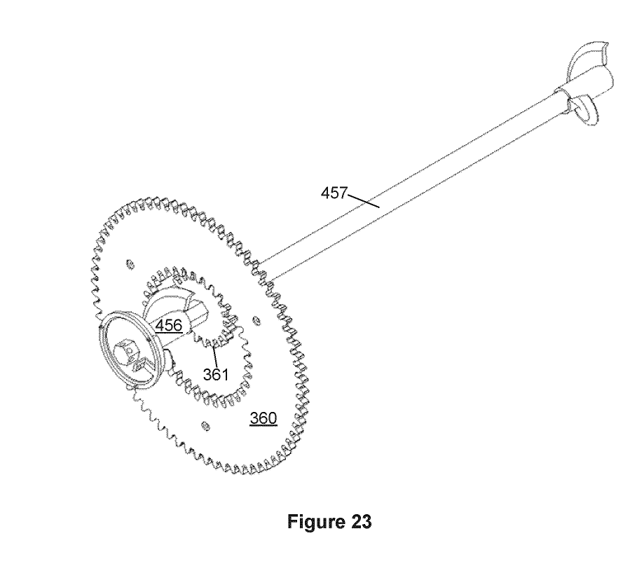

With reference to FIGS. 19, 20 and 21, sewage enters the sewage inlet 364 of the core assembly 352 and falls into a compartment 446 of the separator 354. A portion of the liquid in the sewage exits the compartment 446 of the separator 354 mainly through the slots 403, 405, 434, 436, 438 and 440 of the separator, leaving behind partially drained solids. As the separator 354 rotates about the core assembly 352, the partially drained solids rise along a portion 449 of the circumference of the core assembly 352 to eventually reach an opening 450 of the core assembly 352 and fall into a trough 452, through the opening 450. An auger 456 is disposed in the trough 452 and rotates, in the present example, in the same direction (indicated by the arrow 448 in FIG. 21) as the gear 360, to push the solids in the trough 452 toward the composting drum. As will be understood by the skilled worker, an auger with the opposite handedness would require the direction of rotation to be opposite of that show by arrow 448. FIG. 22 shows a top view of the core assembly 452 with the gear 360 secured thereto. In the embodiment of FIG. 19, the slots (draining slots) 436, 438, 440, and 442 extend along the entire circumference of separator. Further, the hoops 402, 404, and 406 can be referred to as gap inserts, to be inserted in gaps 426, 422, and 424. FIG. 23 shows an exemplary mechanism of how the auger 456 is driven. As shown in FIG. 23, the auger 456 is mounted on a shaft 457 to which is secured a gear 361. The internal portion of the gear 360 engages the gear 361 to rotate the gear 361 and the shaft and auger 456 that are secured to the shaft.

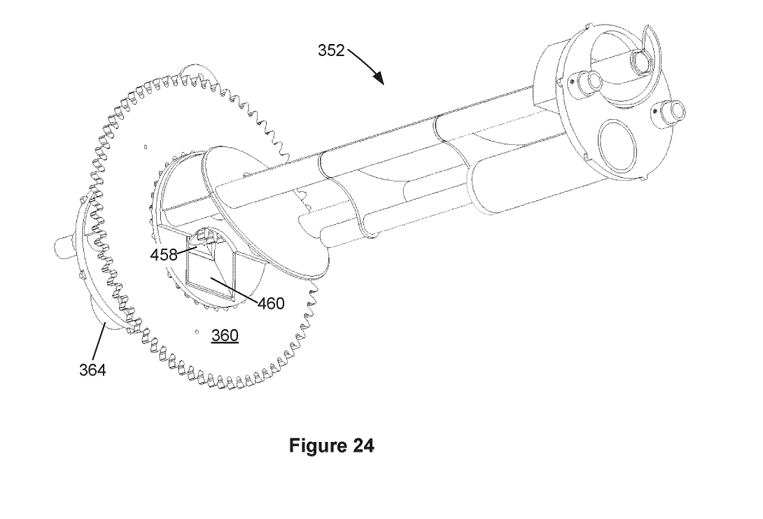

Returning to FIG. 22, as the auger 456 rotates, the solids received in the trough 452 through the opening 450 are pushed towards an exit opening in the core assembly 352. FIG. 24 shows a bottom perspective view of the core assembly 352 to which the gear 360 is rotatably secured. The exit opening through which the solids are pushed by the auger 456 is shown at reference numeral 458 of FIG. 24. As the solids fall out of the exit opening 458, they fall into the composting drum 358 along the wall 460, which may, in certain embodiments, be slanted. The core assembly 352 thus defines a passageway between the separator and the composting drum. The passageway, in the present example, connects the separator to the composting drum, through the exit opening 458.

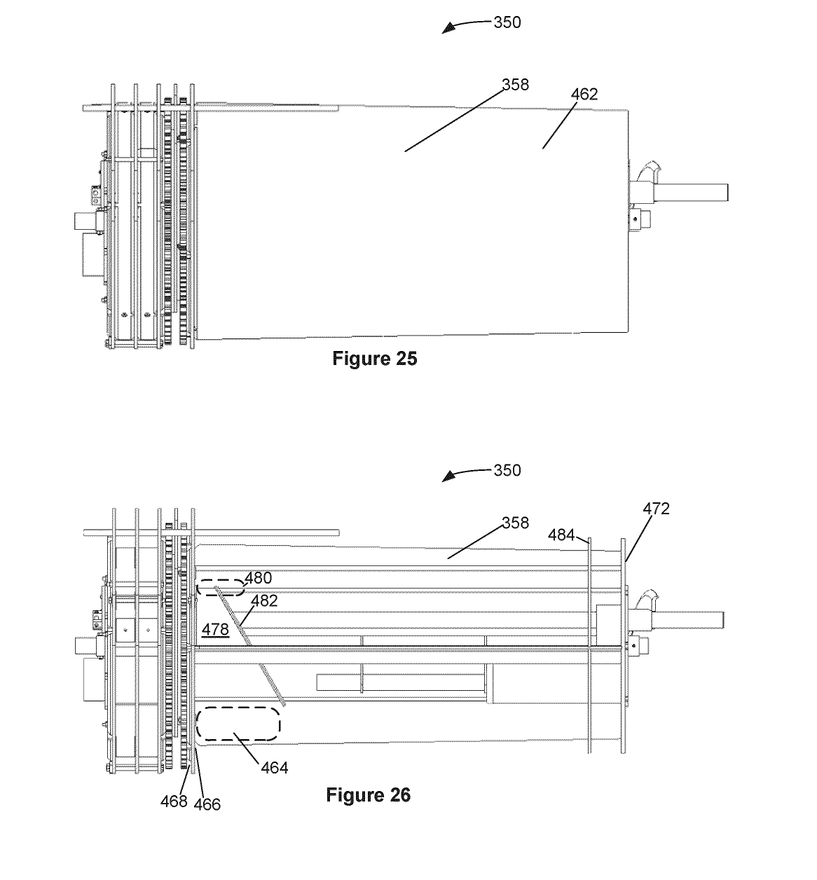

FIG. 25 shows a side view of the separator and composting system 350 where the circumference wall 462 of the composting drum 358 is shown; FIG. 26 shows an open, side view of the separator and composting system 350. When the solids fall out of the exit opening 458 of the core assembly 352 (see FIG. 24), they land in the composting drum 358 generally at the area 464 shown in FIG. 26. The solids present in the composting drum 358 can further drain themselves from liquid trough a slots 466 and 468, which are described below.

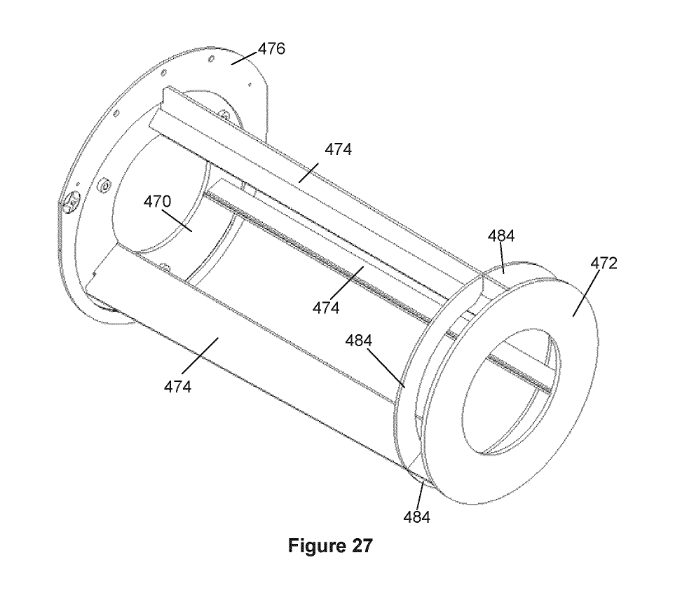

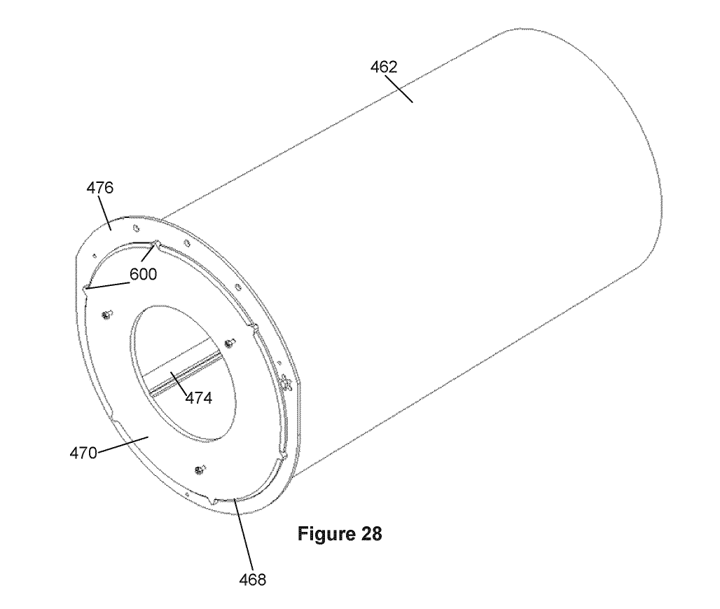

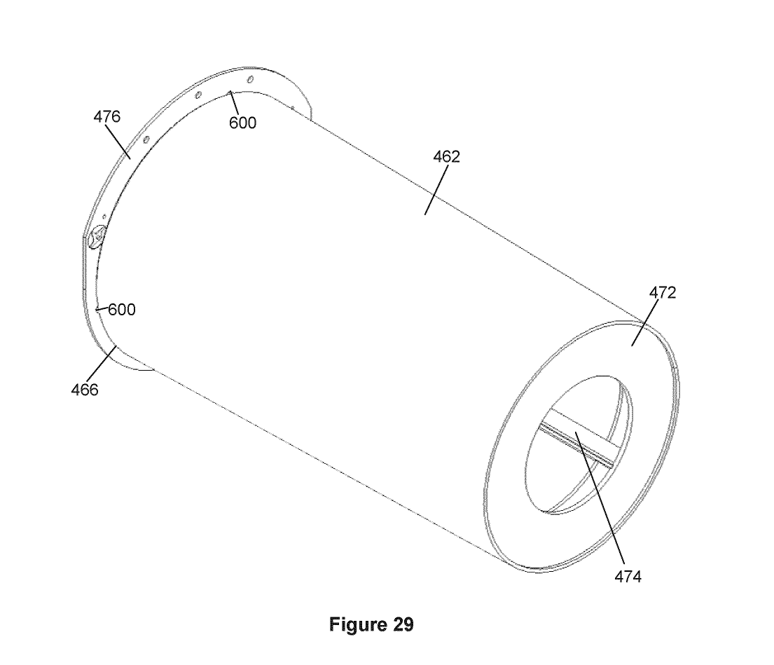

FIG. 27 shows an open, perspective view of the composting drum 358, which has a front wall 470 and a back wall 472, as well as blades 474 that connect the front wall 470 to the back wall 472. The gear 360 discussed earlier is fixedly secured to the front wall 470 though any suitable type of fasteners, adhesives, or both. In other embodiments, the gear 360 and the front 470 wall can be monolithic. The composting drum 358 is shown with a hoop 476 that remains fixed with respect to the core assembly about which the composting drum 358 rotates. FIG. 28 shows another perspective view of the composting drum 358. The hoop 476 is located between the front wall 470 and the circumference wall 462. The slot 468 is defined by the hoop 476 and the front wall 470. FIG. 29 shows yet another perspective view of the composting drum 358. The slot 466 is defined by the hoop 476 and the circumference wall 462. Within the context of the present disclosure, the blades 474 can also be referred to as vanes.

The slots 466 and 468 can have substantially the same width as that of the slots 436, 438, and 440, described above in relation to FIG. 19.

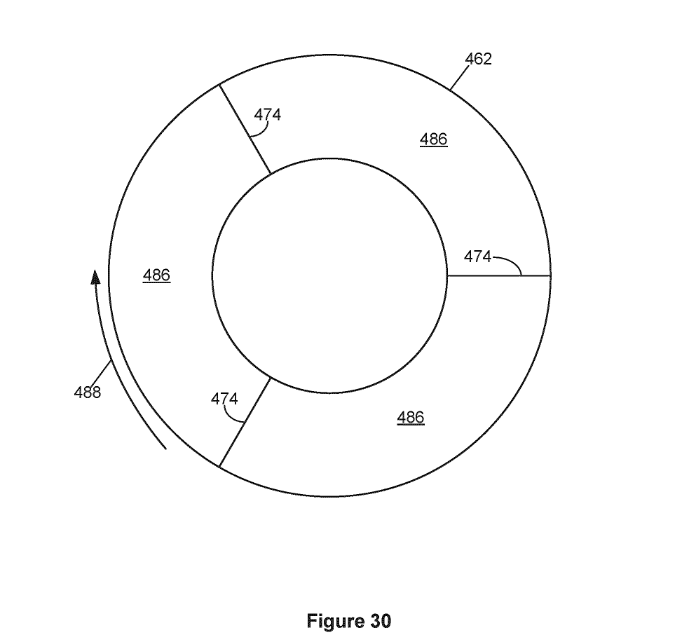

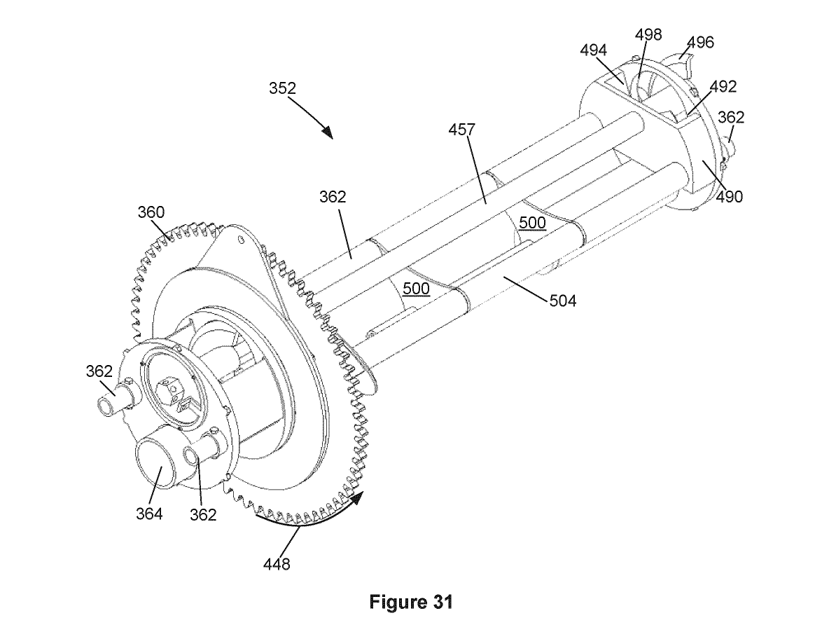

Referring again to FIG. 26, once in the compositing drum 358, the partially drained solids will further drain itself from liquid through the slots 466 and 468. As the composting drum 358 will generally rotate at a lower speed than the separator 354, the partially drained solids will have a greater draining time in the composting drum than in the separator 354. As the composting drum 358 rotates, the further drained solids are lifted, by the blades 474, from the area 464 around an extension 478 of the core assembly 352, towards the top portion 480 of the extension 478. Once at the top portion 480, the solids (further drained solids), or a portion of the solids slide down a sloped wall 482 and are forwarded further into the composting drum 58. As the composting drum 358 continues to rotate, the partially drained solids will propagate towards the back wall 472 of the composting drum, eventually reaching the partition 484 of the composting drum 358. The partition 484 is also shown at FIG. 27. Subsequently, as the composting drum continues to rotate, the solids will fall between the partition 484 and the back wall 472. The back wall 472, the partition 484, the circumference wall 462 (shown in FIG. 29), and the blades 474 define compartments that are eventually reached by the solids in the composting drums. FIG. 30 shows these compartments at reference numeral 486. The rotation direction 488 is as observed when facing the back wall 472.

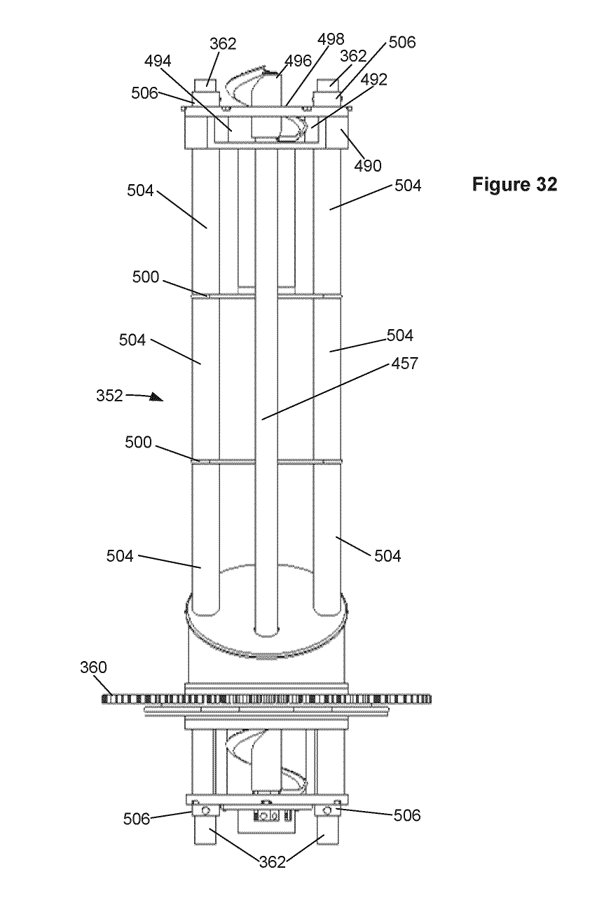

Referring now to FIG. 30 and to FIG. 31, as the composting drum 358 rotates about the core assembly 352, the solids in a compartment 486 rise along a portion 490 of the circumference of the core assembly 352 to eventually reach an opening 492 of the core assembly 352 and fall into a trough 494, through the opening 492. An auger 496 is disposed in the trough 494 and rotates, in the present example, in the same direction (indicated by the arrow 448 in FIG. 21 and by the arrow 488 of FIG. 30) as the gear 360, to push the solids in the trough 452 through an opening 498 and out of the composting drum 358. FIG. 32 shows a top view of the core assembly 452 with the gear 360 secured thereto. The auger 496 is secured to the shaft 457.

As shown in FIGS. 31 and 32, the support members 362 extend from one end of the core assembly 352 to the opposite of the core assembly 352. The support members 362 are threaded through apertures of support plates 500 and through spacers 504, which cover the support members 362 and maintain the support plates 500 at a pre-determined distance from each other. As will be described further below, the support plates 500 serve as a holder for a heating unit. As shown at FIG. 32, fixed collars 506 can be secured to the support member 362.

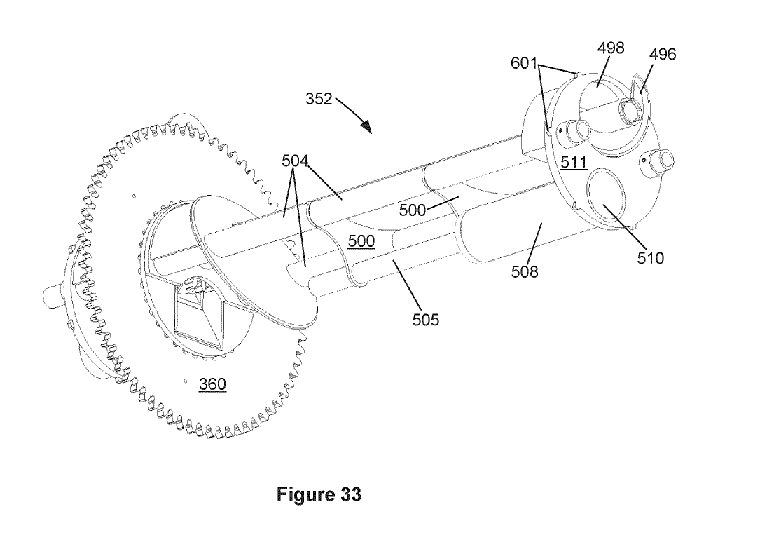

FIG. 33 shows the opening 498 through which the solids are pushed by the auger 496. A compost bin can be disposed beneath the opening 498 to receive the solids form the composting drum 358. Additionally, the opening 498 can serve as a vent for air that comes in the separator-composting unit through the sewage inlet 364. FIG. 33 also shows an optional access tube 508 secured to a sleeve 505, which can be made of stainless steel or of any other suitable heat conducting material. The access tube 508 and the sleeve 505 are supported in the core assembly 352 by the support plates 500 and by the back wall 511 of the core assembly 352. A heater element (not shown) can be inserted in the sleeve 505 to heat up and dry the solids in the composting drum 358. The heater element can be secured in the sleeve 505 in any suitable manner. For example, the heater element and the sleeve 505 could have formed thereon cooperating thread to allow the heater element to be screwed into the sleeve 505. The opening 510 of the access tube can be left open or can be closed whether or not a heater is present in the holder 508.

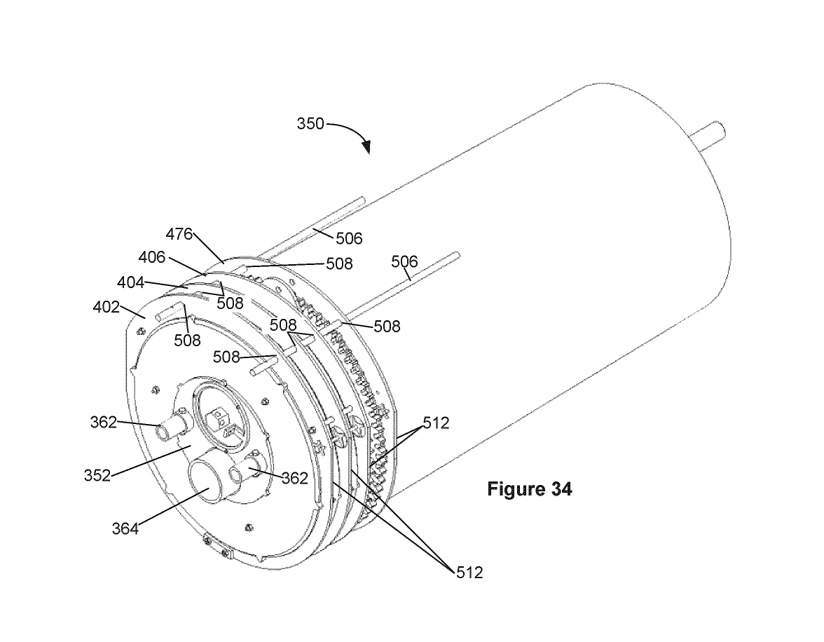

FIG. 34 shows how the hoops 402, 404, 406, and 476 are connected through alignment rods 506. The alignment rods 506 are fitted through holes 508 defined in each of the hoops 402, 404, 406, and 476. When the separator and composting unit 350 is installed in a waste water treatment system or a sewage treatment system, the support members 362 can be fitted in cooperating holders and, the alignment rods can also be fitted in respective cooperating holders. Additionally, or alternatively, the edges 512 can be abutted against an alignment structure (e.g., a wall) to ensure that hoops remain fixed with respect to the core assembly 352.

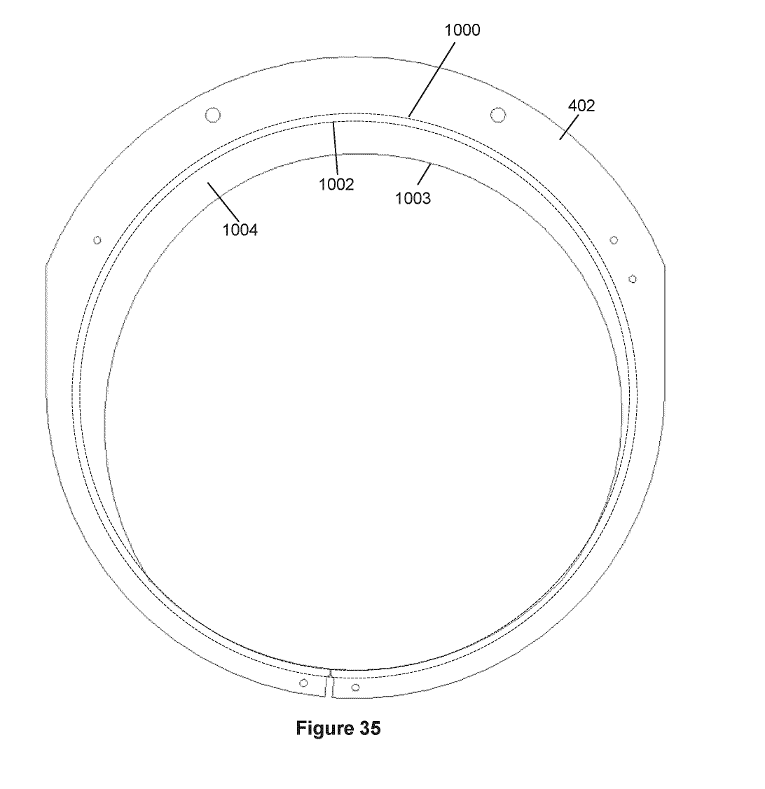

FIG. 35 shows an embodiment of the hoop 402. The dashed circle 1000 represents the outer circumference of the circumference wall 408. The dashed circle 1002 represents the outer diameter of the front wall 400. The interior perimeter 1003 of the hoop 402 is designed to have a portion 1004 of the interior perimeter 1002 protrude inside the separator 354. This serves to push solids accumulated in the separator 354, over the gap 426 (see FIGS. 17 and 19), toward the inside of the separator, thereby preventing blockage of the gap 426. Further, with reference to FIG. 19, the proximity of the portion 1004 of the hoop 402 to the front wall 400 allows the portion 1004 to scrape off any solids, e.g., paper residues, that may accumulate on the front wall 400, in the separator 354. The same principle applies to the hoop 406 and the back wall 414, and to the hoop 476 and the front wall 470. The hoops 404, 406, and 476 can have the same profile as that shown in FIG. 35.

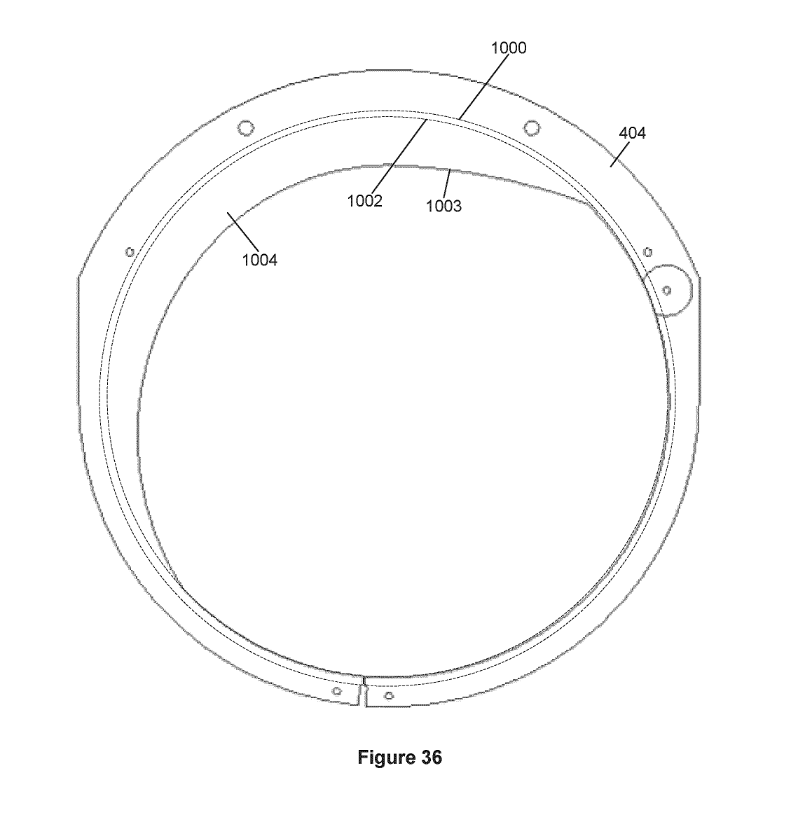

FIG. 36 shown an embodiment of the hoop 404. The dashed circle 1000 represents the outer circumference of the circumference wall 408 (or 410). The dashed circle 1002 represents the outer diameter of the front wall 400. As in the example of FIG. 35, the interior perimeter 1003 of the hoop 404 is designed to have a portion 1004 protrude inside the separator 354 This serves to push solids accumulated in the separator 354, over the gap 422 (see FIGS. 16 and 19), toward the inside of the separator, thereby preventing blockage of the gap 422. As shown in FIG. 36, the inside perimeter of the hoop 404 has less overlap with the edges of the circumference wall 408 and 410, which serves to reduce any friction there may be between the hoop 404 and the circumference walls 408 and 410. The hoops 402, 406, and 476 can have the same profile as that shown in FIG. 35.

Any hoop that has an inside perimeter that protrudes into the separator is to be considered within the scope of the present disclosure. Further, hoops that do not have an inside perimeter that protrudes inside the separator but nevertheless contribute to define slots for draining liquids from the sewage can also to be considered within the scope of the present disclosure.

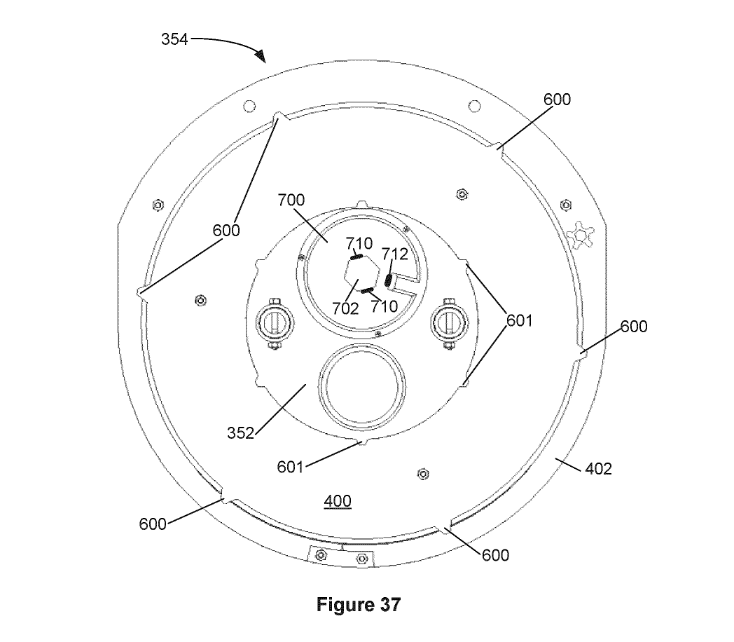

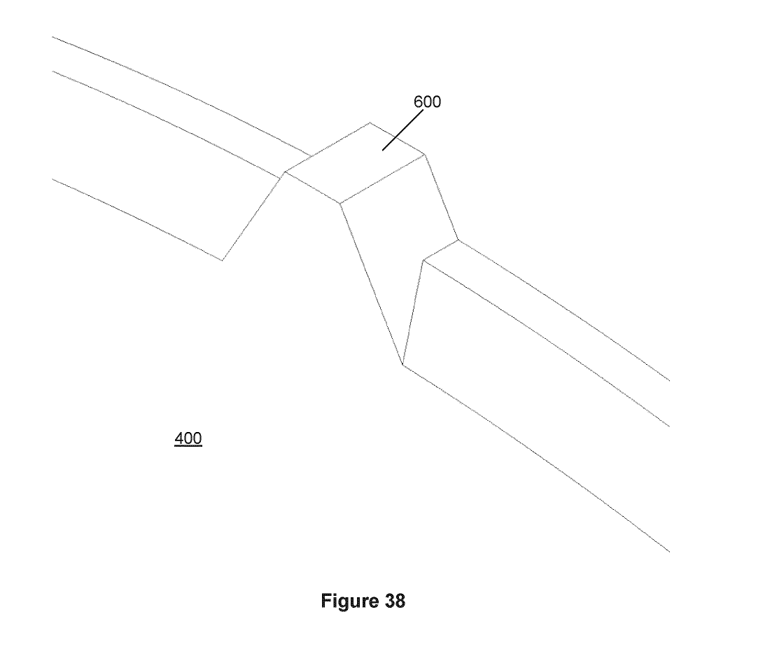

As liquid will drain from the slots defined in the separator 354 and the composting drum 358, there may be a biofilm forming on the surfaces along which the liquid drains. To mitigate the formation of such biofilms, the separator-composting unit can have scraper structures defined thereon to scrape off biofilms accumulating on these surfaces. FIG. 37 shows a front view of the separator 354. The front wall 400 has a number of scraper structures 600 defined thereon. The scraper structures 600 are to scrape off biofilms accumulating on the outside face of hoop 402, particularly at the bottom region of the hoop 402 where liquid is likely to flow out of the separator 354. FIG. 38 shows a close-up view of an embodiment of a scraper structure 600 defined by the front wall 400. Further, the core assembly 352 can have holder structures 601 to about against the front wall 400 to prevent the front wall 400 from moving off the core assembly 352. Similar holder structures 601 can be defined on the back wall 511 of the core assembly 352, as shown at FIG. 33.

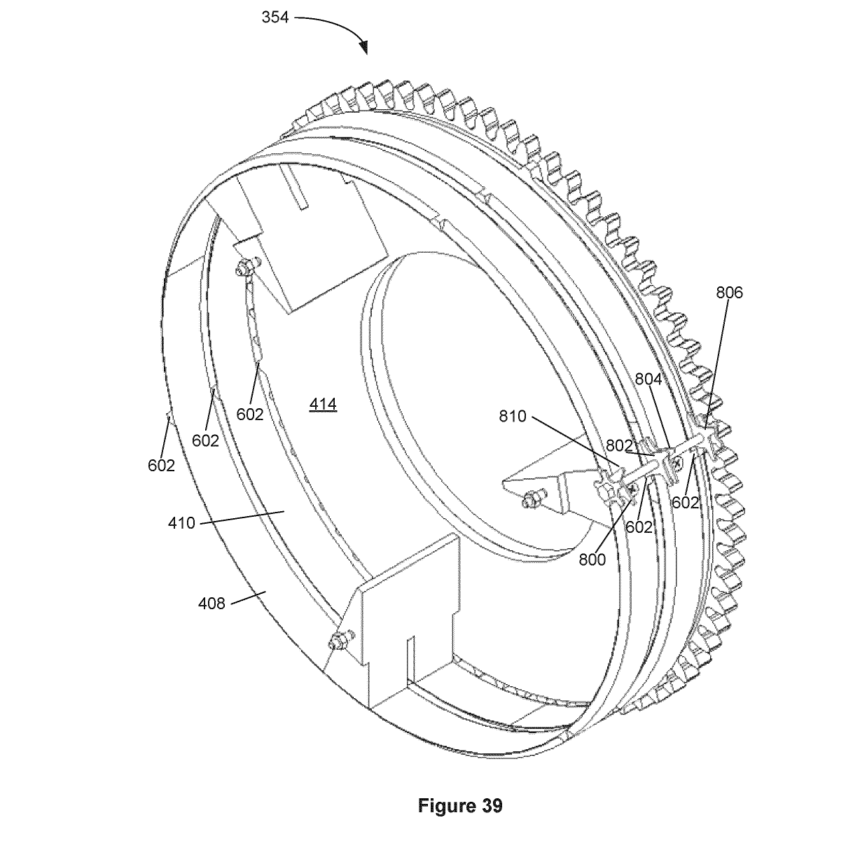

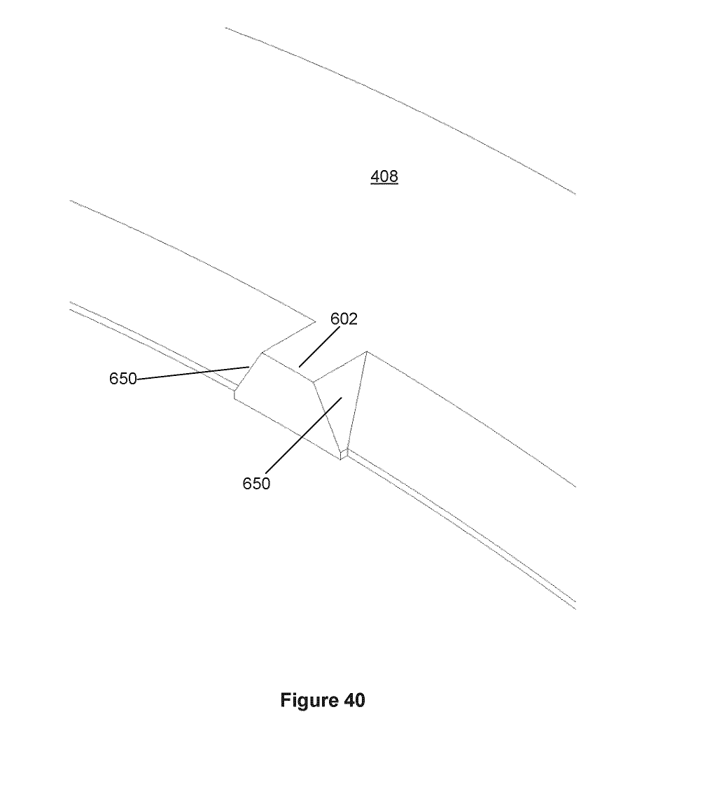

Similarly, and as shown at FIG. 39, the circumference walls 408 and 410 can have scraper structures 602 formed thereon to scrape off biofilms from the hoops 402, 404, and 406 (not shown in FIG. 38). FIG. 40 shows a close up view of a scraper structure 602 formed on the circumference wall 408. As shown at FIG. 40, the scraper structure 602 protrudes laterally from the circumference wall 408 in order to engage the adjacent hoop (not shown). Further, the scraper structure 602 has beveled walls (sloped walls) 650 and a low profile, which help reduce any accumulation of matter on the scraper structure and thereby reduces the risk of blockage.

The back wall 414 can also have scraper structures 600 formed thereon to scrape off biofilms from the hoop 406. Further, any wall adjacent any hoop, can have scraper structures formed thereon to scrape off biofilms formed on the hoop. For example, FIG. 28 shows the front wall 470 with scraper structures 600, and FIG. 28 shows the circumference wall 462 with scraper structures 600. Any number of scraper structures is to be considered within the scope of the present disclosure.

Returning to FIG. 39, slot-cleaning devices 800, 802, 804, and 806 are shown mounted on an axle 808 that is secured to the hoops 402, 404, and 406 (not shown). The slot-cleaning devices 800, 802, 804, and 806 are dimensioned to respectively fit into slots 436, 436, 440, and 442 shown at FIG. 19. The slot-cleaning devices have a plurality of elongated structures 810 design to push any matter accumulated in the slots towards the inside of the separator 354. As the separator 354 rotates, the scraping structures 602 formed on the circumference walls 408 and 408 engage the slot-cleaning devices and cause these to turn. The geometry of the slot-cleaning devices ensure that there is always one elongated structure pushing matter accumulated in the slots towards the inside of the separator 354.

Returning to FIG. 37, a removable cover 700 provides access to the auger 456 (shown at FIG. 23) to allow access to auger, if needed. Further, FIG. 37 shows an hexagonal portion 702 of the shaft 457. The hexagonal shaft portion 702 extends outside the separator 456 and rotates with the shaft. The auger 456 can have a corresponding hexagonal cross-section to allow easy mounting and removal of the auger to or from the hexagonal shaft portion 457. The cover 700, or any other suitable part of the separator and composting unit can be fitted with a sensor assembly to sense a rotation of the shaft portion 700 and of the shaft. For example, the shaft portion can be fitted with magnets 710 and the cover 700 can be fitted with at magnetic field detector 712 to detect a rotation of the shaft. The magnetic field detector 712 can be operationally connected to a processing means that monitors the rotation of the shaft, which is equivalent to monitoring the rotation of the separator and of the composting drum. Upon detecting the that the shaft no longer rotates, the processing means can trigger a maintenance alert.

The separator-composting system (or unit) of the present disclosure can be made of any suitable type of material including, for example, plastics, metals, metal alloys, polymers.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

What is claimed is:

1. A separator and composting unit comprising:
a core assembly;
a separator for receiving sewage, the separator having draining slots defined therein, the draining slots to enable liquid in the sewage to drain out of the separator to obtain partially drained solids in the separator; and
a composting drum, the separator and the composting drum to be rotatably driven about the core assembly, the core assembly defining a passageway between the separator and the composting drum, the separator to displace the partially drained solids toward the passageway upon being rotated, the partially drained solids to enter the passageway upon reaching the passageway, the passageway to transfer the partially drained solid having entered the passageway to the composting drum.

2. The unit of claim 1 wherein the draining slots extends along a circumference of the separator.

3. The unit of claim 2 wherein the separator has:
a first circumference wall;
a second circumference wall spaced apart from the first circumference wall to define a gap therebetween; and
a gap insert located in the gap, the gap insert being fixed with respect to the core assembly, the gap insert and the first circumference wall defining a first draining slot, the gap insert and the second circumference wall defining a second draining slot.

4. The unit of claim 3 wherein the gap insert is a hoop.

5. The unit of claim 3 wherein the separator has:
a front wall;
a back wall opposite the front wall; and
vanes extending from the front wall to the back wall, the front wall, the back wall, the first circumference wall, and the second circumference wall being fixedly secured to the vanes, the vanes to push the partially drained solids toward the passageway upon the separator being rotated.

6. The unit of claim 5 wherein:
the first circumference wall and the front wall are spaced apart and define a front wall gap; and
the second circumference wall and the back wall are spaced apart and define a back wall gap, the separator further having a front wall gap insert inserted in the front wall gap and a back wall gap insert inserted in the back wall gap, the front wall gap insert and the first circumference wall defining third draining slot, the back wall gap insert and the second circumference wall defining a fourth draining slot, the front wall gap insert and the back wall gap insert being fixed with respect to the core assembly.

7. The unit of claim 6 wherein the front wall gap insert is a front wall hoop and the back wall gap insert is a back wall hoop.

8. The unit of claim 1 wherein the core assembly has:
a trough to receive the partially drained solids; and
an auger to push the drained solids out of the through and into the passageway.

9. The unit of claim 1 wherein composting drum has a draining slot defined therein, the draining slot of the composting drum to enable liquid in the partially drained solids to drain out of the composter.

10. The unit of claim 9 wherein the draining slot of the composting drum extends along a circumference of the composting drum.

11. The unit of claim 10 wherein:
the core assembly defines a sloped wall; and
the composter is to displace, upon being rotated, the partially drained solids received from the separator toward a top portion of the sloped wall, the partially drained solids to slide down the sloped wall upon reaching the top portion of sloped wall.

12. The unit of claim 11 wherein the composting drum has:
a composting drum front wall;
a composting drum circumference wall spaced apart from the composting drum front wall to define a composting drum gap therebetween;
a composting drum gap insert located in the composting drum gap, the composting drum gap insert being fixed with respect to the core assembly, the composting drum gap insert and the composting drum circumference wall defining an additional draining slot.

13. The unit of claim 12 wherein the composting drum gap insert is a composting drum hoop fixed with respect to the core assembly.

14. The unit of claim 13 wherein the composting drum further has a composting drum back wall and composting drum vanes extending between the composting drum front wall and the composting drum back wall, the composting drum vanes to push the partially drained solids received from the separator toward the top portion of the sloped wall upon the separator being rotated.

15. The unit of claim 14 wherein the composting drum further has a composting drum exit opening, the vanes also to push the partially drained solids present therein toward the exit opening upon the composting drum being rotated.

16. The unit of claim 15 wherein the composting drum back wall that defines the composting drum exit opening.
